(19) United States
(12) Patent Application Publication
(10) Pub. No.: US 2005/0255011 A1
(43) Pub. Date: Nov. 17, 2005

(54) Plasma fuel reformer with one-piece body

(76) Inventors: Michael W. Greathouse, Columbus, IN (US); Jason Zhang, Canton, MI (US)

Correspondence Address: BARNES & THORNBURG, 11 SOUTH MERIDIAN, INDIANAPOLIS, IN, 46204, US

(21) Appl. No.: 10/843,776

(22) Filed: May 12, 2004

(51) Int. Cl. B01J 19/08; B01J 19/12

(52) U.S. Cl. 422/186.21; 422/186.23

(57) ABSTRACT

A plasma fuel reformer comprises a one-piece body that defines an air passageway and an injector channel. The air passageway is used to supply air for flow through an electrode gap defined between a pair of electrodes. At least a portion of a fuel injector is positioned in the injector channel to supply fuel for flow through the electrode gap.

### FIELD OF THE DISCLOSURE

The present disclosure relates generally to plasma fuel reformers and systems and methods associated therewith.

### BACKGROUND

Plasma fuel reformers reform hydrocarbon fuel into a reformate gas such as hydrogen-rich gas. In the case of a plasma fuel reformer onboard a vehicle or stationary power generator, the reformate gas produced by the reformer may be utilized as fuel or fuel additive in the operation of an internal combustion engine. The reformate gas may also be utilized to regenerate or otherwise condition an emission abatement device associated with the internal combustion engine or as a fuel for a fuel cell.

### SUMMARY

According to an aspect of the present disclosure, a plasma fuel reformer is provided. The plasma fuel reformer comprises a one-piece body that defines an air passageway and an injector channel. The air passageway is used to supply air for flow through an electrode gap defined between a pair of electrodes. At least a portion of a fuel injector is positioned in the injector channel to supply fuel for flow through the electrode gap.

In an exemplary embodiment, the one-piece body is made of epoxy and comprises a supply portion and an atomizer portion secured to the supply portion. The supply portion defines the air passageway, the injector channel, and another air passageway. The atomizer portion is configured to direct air from the air passageways toward fuel supplied by the fuel injector to promote atomization of the fuel for flow of an air-fuel mixture through the downstream electrode gap.

The above and other features of the present disclosure will become apparent from the following description and the attached drawings.

### BRIEF DESCRIPTION OF THE DRAWINGS

FIG. 1 is a sectional view of a plasma fuel reformer comprising an injection assembly with a one-piece body used to supply a mixture of air and fuel for flow through a downstream electrode gap;

FIG. 2 is an enlarged sectional view of the injection assembly of FIG. 1; and

FIG. 3 is a sectional view of another injection assembly for use with the plasma fuel reformer of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

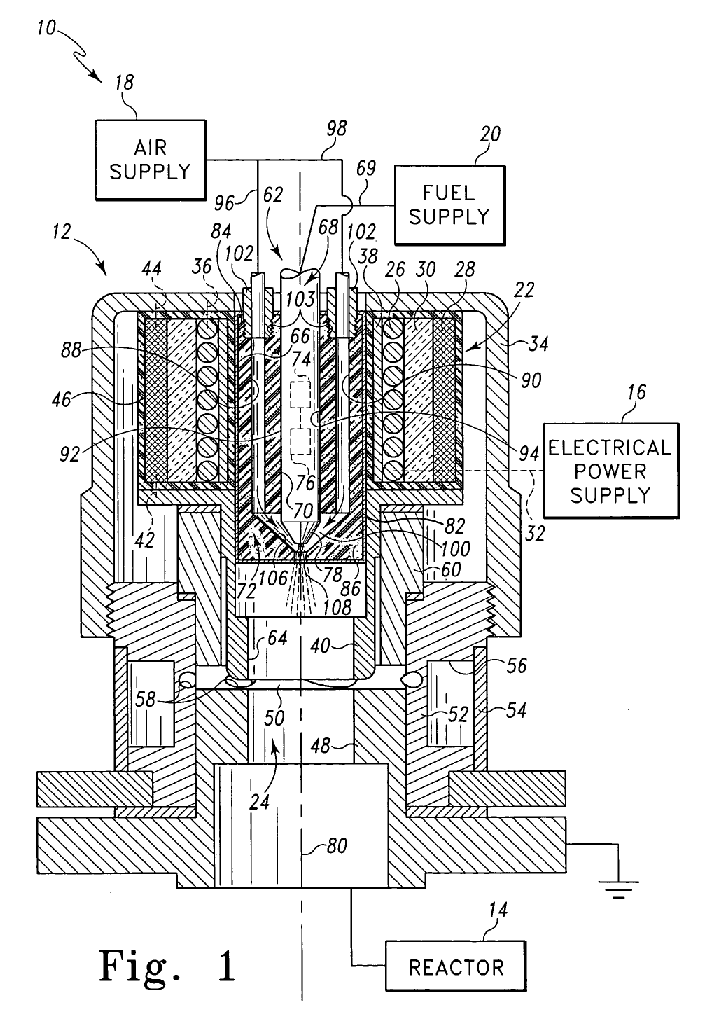

Referring to FIG. 1, there is shown a plasma fuel reformer 10. The plasma fuel reformer 10 uses plasma (an electrically heated gas) to convert a mixture of air and hydrocarbon fuel into a reformate gas which is rich in, amongst other things, hydrogen gas and carbon monoxide. Systems including plasma fuel reformers are disclosed in U.S. Pat. No. 5,425,332 issued to Rabinovich et al.; U.S. Pat. No. 5,437,250 issued to Rabinovich et al.; U.S. Pat. No. 5,409,784 issued to Bromberg et al.; and U.S. Pat. No. 5,887,554 issued to Cohn, et al., the disclosures of which are hereby incorporated by reference. Additional examples of systems including plasma fuel reformers are disclosed in (1) copending U.S. patent application Ser. No. 10/158,615 which is entitled “Low Current Plasmatron Fuel Converter Having Enlarged Volume Discharges,” was filed on May 30, 2002 by A. Rabinovich, N. Alexeev, L. Bromberg, D. Cohn, and A. Samokhin, and is hereby incorporated by reference herein, (2) copending U.S. patent application Ser. No. 10/411,917 which is entitled “Plasmatron Fuel Converter Having Decoupled Air Flow Control,” was filed on Apr. 11, 2003 by A. Rabinovich, N. Alexeev, L. Bromberg, D. Cohn, and A. Samokhin, and is hereby incorporated by reference herein, and (3) copending U.S. patent application Ser. No. 10/452,623 which is entitled “Fuel Reformer With Cap and Associated Method,” was filed on Jun. 2, 2003 by Michael W. Greathouse and Jon J. Huckaby, and is hereby incorporated by reference herein.

Hydrogen-rich gas generated by the fuel reformer 10 may be supplied to an internal combustion engine (not shown) such as a spark-ignited gasoline engine. In such a case, the internal combustion engine combusts the reformate gas as either the sole source of fuel, or alternatively, as a fuel additive to a hydrocarbon fuel. Alternatively, hydrogen-rich gas generated by the fuel reformer 10 may be supplied to a fuel cell (not shown) such as an alkaline fuel cell (AFC), a phosphoric acid fuel cell (PAFC), a proton exchange membrane fuel cell (PEMFC), a solid oxide fuel cell (SOFC), a molten carbonate fuel cell (MCFC), or any other type of fuel cell. In such a case, the fuel cell utilizes the hydrogen-rich gas in the production of electrical energy. The hydrogen-rich gas from the fuel reformer 10 may also be supplied to an emission abatement device such as a NOₓ trap or a soot filter to facilitate regeneration thereof.

The fuel reformer 10 comprises a plasma generator 12 and a reactor 14. The plasma generator 12 generates a plasma arc using electrical power from an electrical power supply 16. A mixture of pressurized air from an air supply 18 and hydrocarbon fuel from a fuel supply 20 passes through the plasma arc and into the reactor 14 to reform the hydrocarbon fuel into a reformate gas.

The plasma generator 12 comprises a transformer 22 to supply a voltage to an electrode assembly 24. The transformer 22 is, for example, a pulse-type, step-up transformer that has an annular shape. The transformer 22 comprises an inner primary coil 26, an outer secondary coil 28, and an annular electrical insulator 30 positioned between the coils 26, 28 to electrically insulate the coils 26, 28 from one another.

The primary coil 26 is electrically coupled at one end to the power supply 16 by an electrical connection 32 and at an opposite end to an electrically grounded cap 34 by an electrical connection 36. The primary coil 26 induces a magnetic flux in an annular core 38 (e.g., a ferrite core) positioned inwardly from the primary coil 26. The induced magnetic flux, in turn, induces a voltage in the secondary coil 28.

The secondary coil 28 is electrically coupled at one end to an annular upper electrode 40 of the electrode assembly 24 by an electrical connection 42 and at an opposite end to the grounded cap 34 by an electrical connection 44. The secondary coil 28 is thus able to supply the induced voltage to the upper electrode 40. The number of windings in the secondary coil 28 is greater than the number of windings in the primary coil 26 so that the induced voltage is greater than the voltage supplied to the primary coil 26. The ratio of the number of windings in the secondary coil 28 to the number of windings in the primary coil 26 is, for example, 1:500. A casing 46 made of, for example, epoxy contains the coils 26, 28, the insulator 30, and the core 38.

Electrode assembly 24 comprises the upper electrode 40 and an electrically grounded annular lower electrode 48. The electrodes 40, 48 are spaced apart from one another to define an electrode gap 50. When energized by the electrical power supply 16, electrodes 40, 48 generate the plasma arc across the electrode gap 50.

An annular intermediate body 52 interconnects the lower electrode 48 and the cap 34 so that the lower electrode 48, the body 52, and the cap 34 are electrically grounded. The body 52 and an annular outer sleeve 54 cooperate to define an annular air chamber 56. Pressurized air from the air supply 18 flows through the air chamber 56 and a plurality of swirl openings 58 defined in body 52 so that pressurized swirl air is discharged into the electrode gap 50 to promote production of reformate gas.

An electrical insulator 60 is positioned between the upper electrode 40 and the lower electrode 48 to electrically insulate the electrodes 40, 48 from one another. The insulator 60 is made of, for example, a ceramic material.

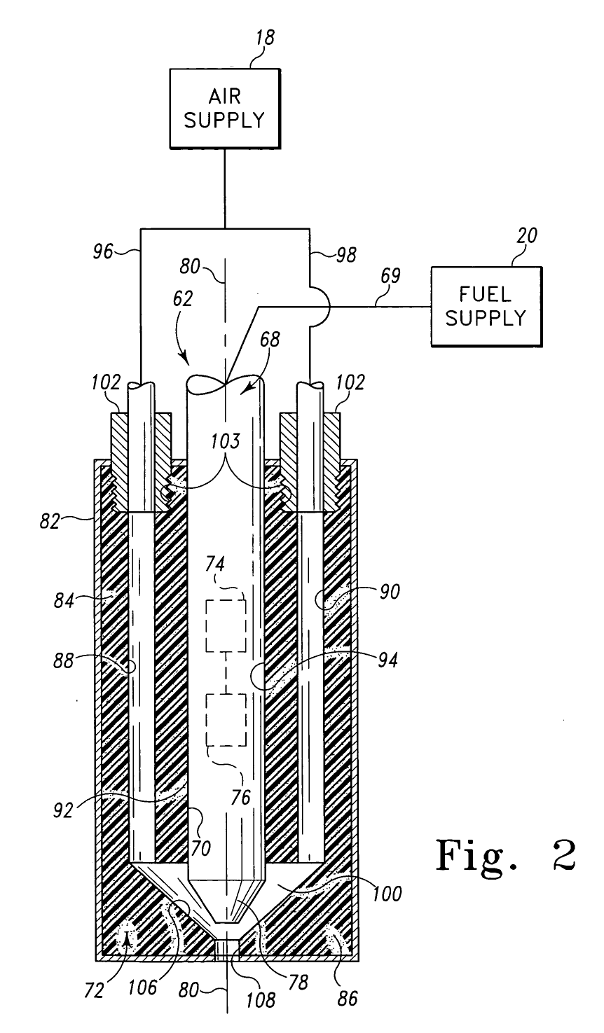

Referring to FIGS. 1 and 2, an injection assembly 62 is configured to inject a mixture of air and fuel into an air-fuel passageway 64 defined in the plasma generator 12 for flow through the electrode gap 50. Injection assembly 62 is positioned in an interior region 66 defined in transformer 22 to reduce electro-magnetic interference with operation of injection assembly 62, as discussed in more detail herein.

The injection assembly 62 comprises a fuel injector 68 fluidly coupled to the fuel supply 20 through a fuel supply line 69 to inject fuel into the plasma generator 12. The fuel injector 68 is mounted in and extends through a central injector channel 70 defined in a one-piece body 72 of injection assembly 62. Fuel injector 68 comprises a valve actuator 74 to move a valve 76 to control discharge of fuel from a nozzle 78. The valve actuator 74 is, for example, a solenoid or a piezo-electric device. The fuel injector 68 is positioned in the center of interior region 66 along a central axis 80 of the reformer 10 to help protect operation of components of the fuel injector 68 such as the valve actuator 74 from electromagnetic radiation generated by the transformer 22.

A magnetic shield 82 houses the one-piece body 72 and the portion of the fuel injector 68 in injector channel 70. As such, the magnetic shield 82 further protects operation of components of the fuel injector 68 such as the valve actuator 74 from electro-magnetic radiation generated by the transformer 22.

The one-piece body 72 comprises a supply portion 84 and an atomizer portion 86 secured thereto. The supply portion 84 defines the injector channel 70 and first and second air passageways 88, 90 between which the injector channel 70 is positioned. An outer surface 92 of the fuel injector 68 mates with an injector channel surface 94 of the injector channel 70 so that the fuel injector 68 is secured to the one-piece body 72 in the injector channel 70. Exemplarily, the supply portion 84 is shaped as a right circular cylinder.

First and second air passageways 88, 90 conduct pressurized air supplied by the air supply 18 from air supply lines 96, 98 to a chamber 100 defined between supply portion 84 and atomizer portion 86. Each supply line 96, 98 comprises a threaded fitting 102 that mates with a threaded mount 103 formed in the body 72.

Atomizer portion 86 is configured to direct pressurized air from the air passageways 88, 90 through chamber 100 toward fuel discharged from the fuel injector 68 to atomize the fuel for flow of an air-fuel mixture through the downstream electrode gap 50. Atomizer portion 86 comprises a frusto-conical inner flow guidance surface 106 that tapers inwardly toward an outlet opening 108 to guide air discharged from the air passageways 88, 90 toward the outlet opening 104. The nozzle 78 is positioned in chamber 100 adjacent the outlet opening 108 to discharge fuel toward the outlet opening 108. The pressurized air atomizes the fuel so that an air-fuel mixture exits the injection assembly 62 through the outlet opening 108 and flows downstream through the air-fuel passageway 64 and the electrode gap 50. Flow guidance surface 106 and outlet opening 104 cooperate so that the interior of atomizer portion 86 is generally funnel-shaped.

Use of the one-piece body 72 eliminates the need to use multiple components to mount fuel injector 68 and provide air passageways 88, 90. Exemplarily, the one-piece body 72 is fabricated as a casting made of epoxy.

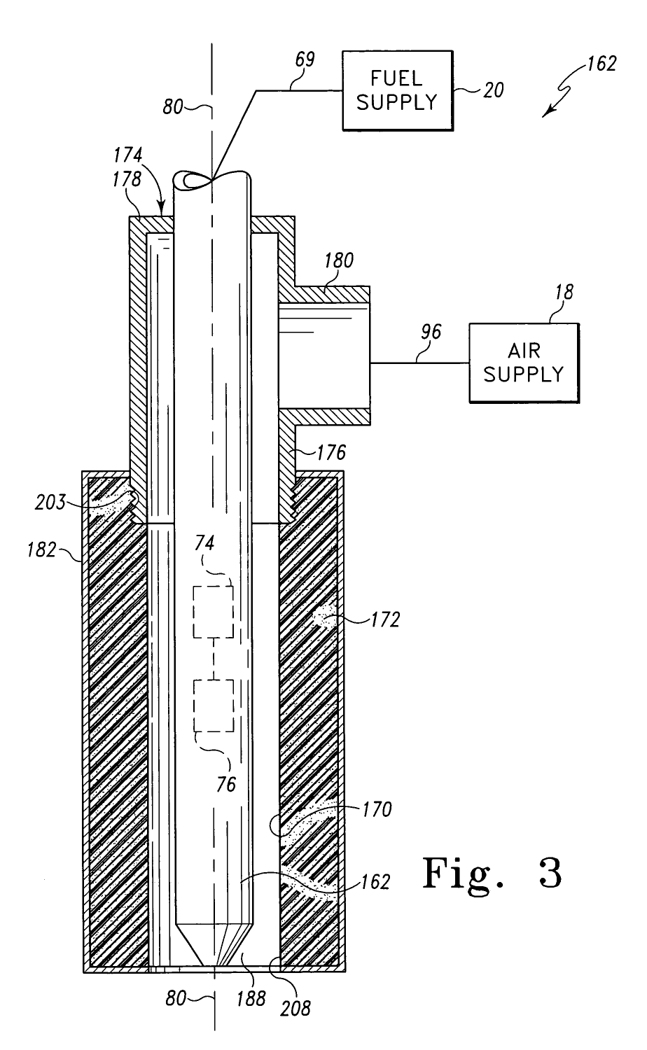

Referring to FIG. 3, there is shown another injection assembly 162 for use with plasma fuel reformer 10 in lieu of the injection assembly 62. Injection assembly 162 is configured to be positioned in the interior region 66 of the transformer 22 in a manner similar to what is shown in FIG. 1 with respect to the injection assembly 62.

The injection assembly 162 comprises a one-piece body 172. Exemplarily, the one-piece body 172 is fabricated as a casting made of epoxy and has a right circular cylindrical shape.

The one-piece body 172 comprises a channel 170. A fuel injector 168 is positioned within the channel 170 in coaxial relation therewith so as to define an annular air passageway 188 between the fuel injector 168 and the channel 170.

A coupler 174 is secured to the one-piece body 172 for introduction of air and fuel into the one-piece body 172. The coupler 174 is T-shaped and comprises a first branch 176, a second branch 178, and a third branch 180. The first branch 176 is threaded to mate with a threaded mount 203 of the one-piece body 172. The fuel injector 168 is secured to the second branch 178 and extends through the first and second branches 176, 178 into the channel 170 to discharge fuel through an outlet opening 208. The air supply line 96 is secured to the third branch 180 to admit air into the coupler 174 for passage through the air passageway 188 and the outlet opening 208 and subsequent mixing with fuel discharged from the fuel injector 168.

A magnetic shield 182 houses the one-piece body 172 and the portion of the fuel injector 168 positioned in the channel 170. The magnetic shield 182 shields the fuel injector 168 and its components (e.g., the valve actuator 74) from electromagnetic radiation generated by the transformer 22.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the apparatus, method, and system described herein. It will be noted that alternative embodiments of the present disclosure may not include all of the features described yet still benefit from at least some of the advantages of such features. Those of ordinary skill in the art may readily devise their own implementations of an apparatus, method, and system that incorporate one or more of the features of the present disclosure and fall within the spirit and scope of the present invention as defined by the appended claims.

1. A plasma fuel reformer, comprising:
first and second electrodes spaced apart from one another to define an electrode gap,
a fuel injector, and
a one-piece body defining (i) an air passageway and (ii) an injector channel in which at least a portion of the fuel injector is positioned.

2. The plasma fuel reformer of claim 1, wherein the one-piece body is positioned upstream from the electrode gap.

3. The plasma fuel reformer of claim 1, wherein the one-piece body defines another air passageway.

4. The plasma fuel reformer of claim 3, wherein the injector channel is positioned between the air passageways.

5. The plasma fuel reformer of claim 1, wherein the fuel injector contacts the one-piece body.

6. The plasma fuel reformer of claim 1, further comprising a magnetic shield housing the one-piece body.

7. The plasma fuel reformer of claim 6, further comprising a transformer defining an interior region in which the one-piece body housed in the magnetic shield is positioned.

8. The plasma fuel reformer of claim 1, wherein the one-piece body is made of epoxy.

9. A plasma fuel reformer, comprising:
first and second electrodes spaced apart from one another to define an electrode gap,
a fuel injector configured to supply fuel for flow through the electrode gap, and
a one-piece body to which the fuel injector is secured, the one-piece body defining (i) an air passageway to supply air for flow through the electrode gap and (ii) an injector channel in which at least a portion of the fuel injector is positioned.

10. The plasma fuel reformer of claim 9, wherein the injector channel comprises an injector channel surface, and the fuel injector comprises an outer surface mating with the injector channel surface.

11. The plasma fuel reformer of claim 9, wherein the one-piece body defines an outlet opening to discharge air and fuel from the one-piece body upstream from the electrode gap.

12. The plasma fuel reformer of claim 11, wherein the one-piece body comprises an inner air flow guidance surface tapering inwardly toward the outlet opening to promote atomization of fuel supplied by the fuel injector.

13. The plasma fuel reformer of claim 9, wherein the one-piece body comprises a mount for attachment to an air supply line.

14. A plasma fuel reformer, comprising:
first and second electrodes spaced apart from one another to define an electrode gap,
a fuel injector configured to supply fuel for flow through the electrode gap, and
a one-piece epoxy body to which the fuel injector is secured, the one-piece epoxy body defining (i) first and second air passageways to supply air for flow through the electrode gap and (ii) an injector channel in which at least a portion of the fuel injector is positioned.

15. The plasma fuel reformer of claim 14, wherein the injector channel is positioned between the first and second air passageways.

16. The plasma fuel reformer of claim 14, wherein the one-piece epoxy body defines a chamber to receive air from the first and second air passageways, and the fuel injector extends from the injector channel into the chamber.

17. The plasma fuel reformer of claim 16, wherein the one-piece epoxy body comprises (i) a supply portion defining the first and second air passageways and the injector channel and (ii) an atomizer portion that is secured to and cooperates with the supply portion to define the chamber and that defines an outlet opening for discharge of atomized fuel from the chamber.

18. The plasma fuel reformer of claim 14, further comprising a magnetic shield housing the one-piece epoxy body.

19. The plasma fuel reformer of claim 18, wherein the magnetic shield contacts the one-piece epoxy body.

20. The plasma fuel reformer of claim 14, further comprising a transformer defining an interior region, and the one-piece epoxy body and the portion of the fuel injector positioned in the injector channel are positioned in the interior region.
